(19) United States
(12) Patent Application Publication
(10) Pub. No.: US 2019/0285438 A1
(43) Pub. Date: Sep. 19, 2019

(54) SENSOR CIRCUITRY

(71) Applicant: Cirrus Logic International Semiconductor Ltd., Edinburgh (GB)

(72) Inventors: Mengde WANG, Austin, TX (US); Zhong YOU, Austin, TX (US)

(73) Assignee: Cirrus Logic International Semiconductor Ltd., Edinburgh (GB)

(21) Appl. No.: 16/354,449

(22) Filed: Mar. 15, 2019

Related U.S. Application Data
(60) Provisional application No. 62/643,400, filed on Mar. 15, 2018.
(60) Provisional application No. 62/656,719, filed on Apr. 12, 2018.

(51) Int. Cl. G01D 5/24

(52) U.S. Cl. CPC G01D 5/24

(57) ABSTRACT

Embodiments described herein relate to methods and apparatus for separating an interference signal from a carrier signal for sensing a capacitance of a capacitive sensor. An analog front end, AFE, circuit for a capacitive sensor comprises an input configured to receive an input signal from the capacitive sensor, wherein the input signal comprises a carrier signal and an interference signal; a first signal path between the input and an output configured to output an output signal, wherein the first signal path is configured with a first impedance at a frequency of the interference signal; and a second signal path coupled to the input, wherein the second signal path is configured with a second impedance at the frequency of the interference signal, wherein the second impedance is lower than the first impedance so as to reduce a voltage swing caused by the interference signal at the input.

### TECHNICAL FIELD

Embodiments described herein relate to methods and apparatus for removing an interference signal from a carrier signal in a capacitive sensor.

### BACKGROUND

In transducers, for example micro-speakers, a capacitive sensor may be used to sense the position of the transducer diaphragm. For example, FIG. 1 illustrates a capacitive sensor 120 in a micro-speaker 100.

The micro speaker 100 may comprise a housing 104 surrounding a diaphragm 106 and a motor assembly 108. The motor assembly 108 may comprise a voice coil 110 and a magnet 112. More particularly, diaphragm 106 may be connected to housing 104 by a speaker surround 114 that allows diaphragm 106 to move axially with pistonic motion, i.e., forward and backward. Furthermore, diaphragm 106 may be connected to voice coil 110 of motor assembly 108, which moves relative to magnet 112 of motor assembly 106. Thus, when an electrical audio input signal is input to the voice coil 110, a mechanical force may be generated that moves diaphragm 106 to radiate sound forward through one or more ports 116 in housing 104.

The available travel distance of diaphragm 106 within micro speaker 100 may be limited. For example, diaphragm 106 may be separated from housing 104 on a front side, and/or separated from a top plate 118 on a rear side, by only a few millimeters or in some cases less than 1 mm. To prevent diaphragm 106 from contacting housing 104 or top plate 118 during use, the driver design may include dimensional tolerances that account for an expected frequency-dependent diaphragm displacement. However, given that frequency response can vary based on operating temperatures, material nonlinearities such as creep, acoustic loading, and/or aging of the driver, the dimensional tolerances may be difficult to predict accurately. This lack of accurate prediction may result in underestimation of the dimensions, and can result in acoustic distortion or damage to diaphragm 106 if it crashes into an opposing surface. Alternatively, overestimation of the dimensions may result in wasted space, since diaphragm 106 may not fully utilize the available space, which may limit the amount of potential maximum acoustic output, the output being directly proportional to the volume displacement of air by the diaphragm 106.

As the diaphragm 106 oscillates forward and backward to generate the sound, a back surface of diaphragm 106 may oscillate closer to and farther from a front surface of magnet 112. In this example, several capacitive plate sections 120 may be supported on magnet 112 behind diaphragm 106, and thus, diaphragm 106 may oscillate closer to and farther from the capacitive plate sections 120 during the sound generation.

The diaphragm 106 and each capacitive plate section 120 may incorporate a conductive material. For example, diaphragm 106 may include a conductive layer disposed over a front or back side, or embedded within the body of diaphragm 106. Similarly, capacitive plate sections 120 may be formed wholly or partially from conductive material. Thus, each capacitive plate section 120 may include a conductive portion that pairs with a conductive portion of diaphragm 106 to essentially form a parallel-plate capacitor. That is, a capacitance may exist for each capacitive plate section 120 and diaphragm 106 pairing. Furthermore, given that the distance between diaphragm 106 and capacitive plate section 120 may vary with movement of diaphragm 106 during sound generation, the capacitances corresponding to each capacitive plate section 120 and diaphragm 106 pairing may also vary. Thus, each pairing may essentially form a variable capacitor.

Capacitance between each pair of conductive surfaces of diaphragm 106 and capacitive plate section 120 will be inversely proportional to the separation distance between the capacitive plate section 120 and the diaphragm 106. Thus, a sensing circuit 122 may be electrically connected with one or more of the capacitive plate sections 120 by one or more electrical leads 124 to receive an electrical signal that may be used to measure capacitance. The measured capacitance may then be used to calculate a corresponding distance between diaphragm 106 and capacitive plate sections 120 based on the known relationship between the capacitance and the separation distance. Similarly, the measured capacitance may be used to determine the displacement and motion of diaphragm 106.

### SUMMARY

According to some embodiments, there is provided an analog front end, AFE, circuit for a capacitive sensor. The AFE circuit comprises an input configured to receive an input signal from the capacitive sensor, wherein the input signal comprises a carrier signal and an interference signal; a first signal path between the input and an output configured to output an output signal, wherein the first signal path is configured with a first impedance at a frequency of the interference signal; and a second signal path coupled to the input, wherein the second signal path is configured with a second impedance at the frequency of the interference signal, wherein the second impedance is lower than the first impedance so as to reduce a voltage swing caused by the interference signal at the input.

In some embodiments, the first signal path is configured with a third impedance at a frequency of the carrier signal and the second signal path is configured with a fourth impedance at the frequency of the carrier signal, wherein the third impedance is lower than the fourth impedance.

In some embodiments, the first signal path comprises a first low pass filter configured to filter high frequency components of the interference signal out of the first signal path.

In some embodiments, the second signal path comprises a high pass filter configured to filter the carrier signal out of the second signal path.

In some embodiments, the high pass filter is configured to pass the interference signal through the second signal path. In some embodiments, the high pass filter comprises an Nth order filter where N>6.

In some embodiments, the second signal path comprises a notch filter configured to allow at least one frequency component of the interference signal to pass through the second signal path. The second signal path may further comprise a second high pass filter configured to pass higher frequency components of the interference signal than the at least one frequency component into the second signal path. The at least one frequency component may comprise a fundamental frequency of the interference signal.

The notch filter may comprise an active inductor. In some embodiments, the active inductor comprises two transconductance amplifiers and two capacitors.

In some embodiments, the interference signal has a higher frequency than the carrier signal.

According to some embodiments there is provided, a method for separating an interference signal from a carrier signal for sensing a capacitance of a capacitive sensor. The method comprises receiving an input signal from the capacitive sensor, wherein the input signal comprises a carrier signal and an interference signal; separating the input signal into the carrier signal and the interference signal by: providing a first signal path between the input and an output for outputting an output signal, wherein the first signal path is configured with a first impedance at a frequency of the interference signal; and providing a second signal path coupled to the input, wherein the second signal path is configured with a second impedance at the frequency of the interference signal, wherein the second impedance is lower than the first impedance so as to reduce a voltage swing caused by the interference signal at the input.

### BRIEF DESCRIPTION OF THE DRAWINGS

For a better understanding of the embodiments of the present disclosure, and to show how it may be put into effect, reference will now be made, by way of example only, to the accompanying drawings, in which:

FIG. 1 illustrates an example of a capacitive sensor in a micro-speaker;

FIG. 2 illustrates an electronic device comprising a transducer in accordance with some embodiments;

FIG. 3 illustrates an example of a capacitance digital converter system for determining the position of the diaphragm in accordance with some embodiments;

FIG. 4 illustrates an example of an analog front end, AFE, circuit for a capacitive sensor;

FIG. 5 is a graph illustrating an example of the impedance of the first signal path and the second signal path as a function of frequency;

FIG. 6 illustrates an example of a high pass filter in accordance with some embodiments;

FIG. 7 illustrates an example of an analog front end, AFE, circuit for a capacitive sensor;

FIG. 8 is a graph illustrating an example of the impedance of the first signal path and the second signal path as a function of frequency;

FIG. 9 is a flow chart diagram illustrating a method for separating an interference signal from a carrier signal for sensing a capacitance of a capacitive sensor in accordance with some embodiments.

### DESCRIPTION

The description below sets forth example embodiments according to this disclosure. Further example embodiments and implementations will be apparent to those having ordinary skill in the art. Further, those having ordinary skill in the art will recognize that various equivalent techniques may be applied in lieu of, or in conjunction with, the embodiment discussed below, and all such equivalents should be deemed as being encompassed by the present disclosure.

Embodiments described herein provide methods and apparatus for removing an interference signal from a carrier signal in an analog front end circuit of a capacitive senor circuit.

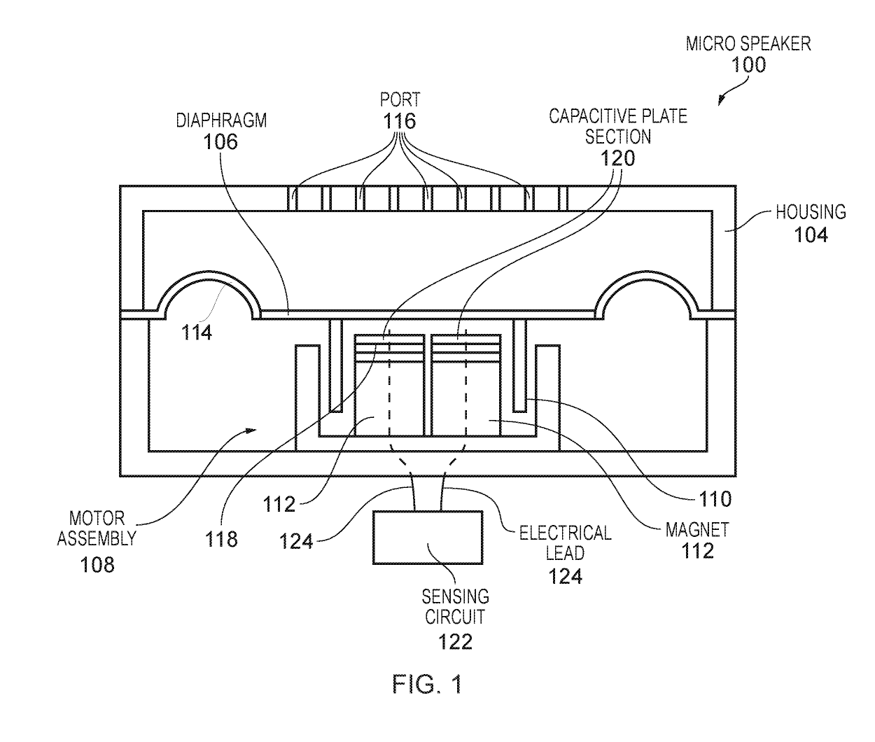

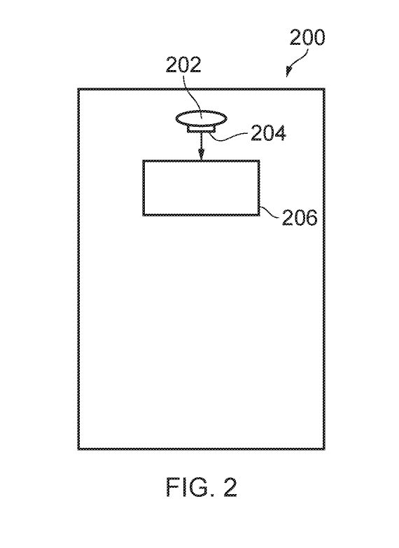

FIG. 2 illustrates an electronic device 200 comprising a transducer 202. The transducer 202 may comprise, for example, a micro-speaker or a haptic transducer. The electronic device 200 may be: a portable device; a battery power device; a computing device; a communications device; a gaming device; a mobile telephone; a personal media player; a laptop, tablet or notebook computing device, smart watch, a virtual reality (VR) or augmented reality (AR) device, or a smart home device, for example. In particular, the transducer 202 may comprise a micro-speaker 100 as illustrated in FIG. 1 having a capacitive sensor 204, which may for example comprise capacitive plate sections 120 as illustrated in FIG. 1.

It will be appreciated that the transducer 202 may also comprise a haptic transducer, for example a linear resonant actuator (LRA). In these examples, the capacitive plate sections 120 may be configured to measure the position of a moving mass of the LRA.

The electronic device 100 may comprise a capacitance digital converter system 206 coupled to receive an input signal from the capacitive sensor 204 for determining the position of the diaphragm or moving mass of the transducer 202.

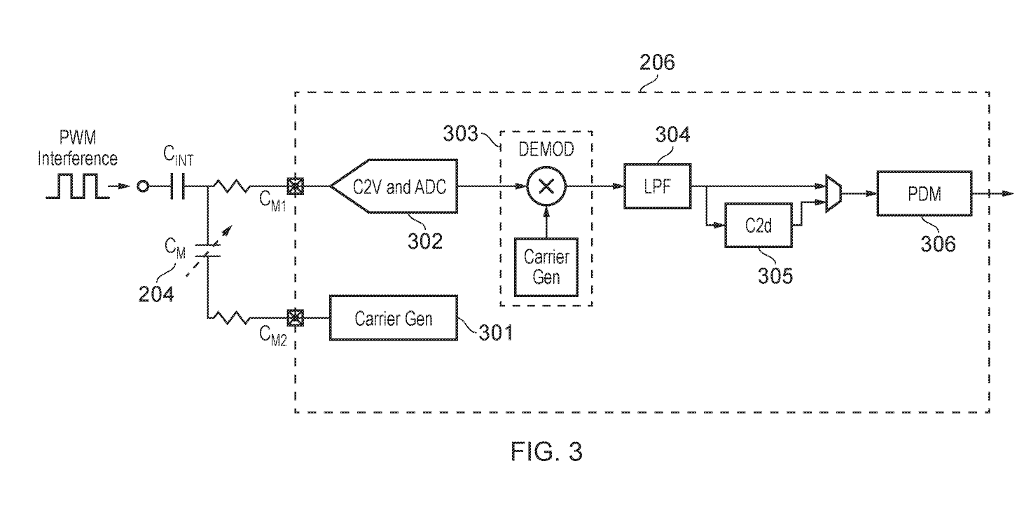

FIG. 3 illustrates an example of a capacitance digital converter system 206 for determining the position of the diaphragm or moving mass of the transducer 202.

The capacitive digital converter system 206 comprises a carrier signal generator 301 configured to generate a carrier signal for driving through the capacitive sensor 204. The capacitive digital converter system 206 comprises an output C_{M2} coupled to drive the carrier signal, output by the carrier signal generator 301, to a plate of the capacitive sensor 204. For example, the output C_{M2} may be coupled to one of the capacitive plate sections 120 as illustrated in FIG. 1.

The capacitive digital convertor system 206 further comprises an input C_{M1} configured to sense the current through the capacitive sensor 204. For example, the input C_{M1} may be coupled to one of the capacitive plate sections 120 as illustrated in FIG. 1.

The capacitive digital converter system further comprises a charge to voltage (C2V) and analog to digital (ADC) converter 302. The C2V and ADC converter 302 converts the sensed current at the input C_{M1} into a voltage signal and converts the voltage signal into a digital voltage signal.

The digital voltage signal is then input into a demodulation block 303 which is configured to demodulate the voltage signal from generated carrier signal. The result is the signal generated by the displacement of the diaphragm or moving mass of the transducer causing a change in the capacitance of the capacitive sensor 204. The demodulated signal is therefore representative of the capacitance of the capacitive sensor 204

This demodulated signal may then be low pass filtered by a low pass filter 304 to avoid any Signal to Noise Ratio (SNR) degradation that may be caused by high frequency noise generated by the demodulation process.

The demodulated signal may then be converted into a representation of the displacement of the diaphragm or moving mass by a capacitance to displacement (C2d) converter 305. This representation of the displacement may then be used in a feedback mechanism to control the displacement of the diaphragm or moving mass. In some examples, the output of the C2d converter 205 is converted into a Pulse Density Modulation (PDM) signal by a PDM block 306 for use by a further processer(s) in reading and using the diaphragm or moving mass displacement.

However, the positioning of the capacitive sensor within the transducer 202 may be close to the voice coil in the transducer, for example as illustrated in FIG. 1, and therefore a parasitic capacitance may be present between the voice coil 110 and the capacitive sensor 120. This parasitic capacitance is illustrated by the parasitic capacitor C_{INT} in FIG. 3. Due to this parasitic capacitance, any signal driving the voice coil, in other words the output signal driving the transducer (in FIG. 3 this is illustrated as a PWM Interference), may pass through the parasitic capacitance C_{INT} between the voice coil and the capacitive sensor creating an interference in the signal measured across the capacitive sensor.

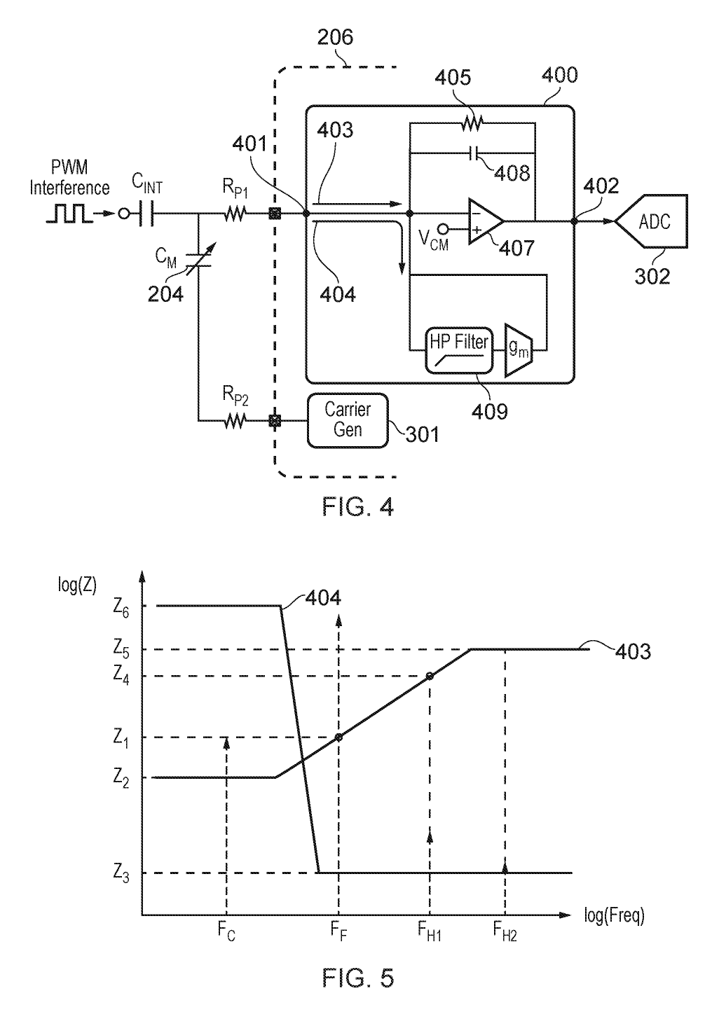

FIG. 4 illustrates an example of an analog front end, AFE, circuit 400 for a capacitive sensor according to some embodiments. It will be appreciated that the AFE circuit may be used in a capacitance digital converter system 206 as illustrated in FIG. 2. Parts of the capacitance digital converter system 206 are illustrated in FIG. 4 for clarity.

In some examples, the carrier signal may be designed to be of a low frequency in order to separate the carrier signal from any interference signals. In these examples, the carrier signal may be of a lower frequency than the interference signal. However, in some embodiments the carrier signal may be of a high frequency. In these examples, the carrier signal may be of a higher frequency than the interference signal.

The AFE circuit comprises an input 401 configured to receive an input signal from the capacitive sensor 204 wherein the input signal comprises a carrier signal and an interference signal. The interference signal may, for example, have a higher frequency than the carrier signal. For example, the input 401 may be coupled to the input C_{M1} of the capacitance digital converter system 206. The carrier signal may be generated by a carrier signal generator 301 as described in FIG. 3, for the purpose of measuring the capacitance of the capacitive sensor C_{M}. The interference signal may be due to a parasitic capacitance C_{INT} between a voice coil in a transducer and the capacitive sensor C_{M} as previously described.

The AFE circuit 400 further comprises a first signal path 403 between the input 401, and an output 402 configured to output an output signal, wherein the first signal path 403 is configured with an impedance Z₁ at a frequency of the interference signal (see FIG. 5 for impedance versus frequency relationship). FIG. 4 illustrates an example of the first signal path 403, and it will be appreciated that other elements may be included (or some elements removed from this first signal path). The first signal path 403 may also be configured with an impedance Z₂ at a frequency of the carrier signal, where the Z₂ is lower than Z₁.

In this example, the first signal path 403 comprises an active low pass filter comprising a resistor 405, capacitor 406 and amplifier 407 coupled in parallel. It will be appreciated that any low pass filter may be used.

The AFE circuit 400 further comprises a second signal path 404 coupled to the input 401. The second signal path 404 is configured with an impedance Z₃ at a frequency of the interference signal, wherein the Z₃ is lower than Z₁. FIG. 4 illustrates an example embodiment of a second signal path 404. In particular, the second signal path 404 may be configured with a lower impedance at a frequency of the interference signal than the first signal path 403 so as to reduce a voltage swing caused by the interference signal at the input 401.

In this example, the second signal path 404 comprises a signal loop comprising a high pass filter 409. The high pass filter 409 presents a high impedance to the low frequencies in the input signal, in other words, the frequencies of the carrier signal. The high pass filter 409 also presents a low impedance to the frequency of the interference signal. It will be appreciated that the interference signal may comprise components of different frequencies. In this embodiments, the high pass filter 409 may present a low impedance to all frequencies of the interference signal.

FIG. 5 illustrates a graph of the impedance of the first signal path 403 and the second signal path 404 as a function of frequency.

In this example, the first signal path 403 has an impedance Z₂ at the frequency of the carrier signal, F_{C}. In this example, the first signal path 404 has impedances Z₄ and Z₅ at the higher harmonic frequencies F_{H1} and F_{H2} of the interference signal respectively, where Z₄ and Z₅ are higher than Z₂. In this example, the first signal path 403 has an impedance Z₁, which is between Z₂ and Z₄, at the fundamental frequency of the interference signal F_{F}. In this example, two harmonic frequencies are shown, however it will be appreciated that further harmonics may be present in the interference signal.

This first signal path 403 therefore, without the presence of the second signal path, may be effective at filtering out the higher harmonic frequencies F_{H1}, F_{H2} of the interference signal from the first signal path 403. However, this first signal path may be less effective at filtering out the fundamental frequency of the interference signal F_{F}, potentially due to the fundamental frequency of the interference signal F_{F} being relatively close to the frequency of the carrier signal F_{C}. Therefore, without the second signal path 404, the fundamental frequency of the interference signal may cause interference effects in the first signal path 403 which may cause the determination of the displacement of the diaphragm of the transducer to be inaccurate.

In this example however, the second signal path 404 is configured with an impedance Z₆ at the frequency of the carrier signal F_{C}, which is higher than the impedance Z₂ to the frequency of the carrier signal in the first signal path 403, thereby ensuring that the carrier signal is passed through the first signal path 403 to be sensed accurately. In this example, the second signal path 404 has an impedance Z₃ at the fundamental frequency of the interference signal F_{F} and at the higher harmonic frequencies F_{H1}, F_{H2} of the interference signal. The impedance Z₃ of the second signal path for the frequencies of the interference signal may be lower than the impedance Z₁ of the first signal path for the fundamental frequency of the interference signal, and lower than the impedances Z₄ and Z₅ for the higher harmonic frequencies in the first signal path.

Therefore, the frequencies of the interference signal will be separated from the first signal path 403, and will instead pass through the second signal path 404 where the frequencies of the interference signal are met with a lower impedance. The configuration of the impedances of the first and second signal paths at different frequencies therefore predominantly removes the interference signal from the first signal path 403, allowing the output signal at the output 402 to be based on the carrier signal.

FIG. 6 illustrates an example of a high pass filter 409 according to some embodiments.

In some embodiments, the fundamental frequency F_{F} of the interference signal may be close in frequency to the carrier signal. In these examples, the high pass filter 409 may comprise a high order high pass filter, for example an N^{th} order filter where N is an integer value greater than 2. It will be appreciated that the closer the frequency of the interference signal is to the carrier signal, the higher order of high pass filter may be required. In some examples, the high order high pass filter 409 may comprise an N^{th} order filter where N is an integer value greater than 5.

In the example illustrated in FIG. 6, the high pass filter 409 comprises a 3^{rd} order Gm-C high pass filter and is an example implementation of a high pass filter 409 that may be used. High pass filter 409 is an example of an active high pass filter, however, it will be appreciated that passive high pass filters may be used.

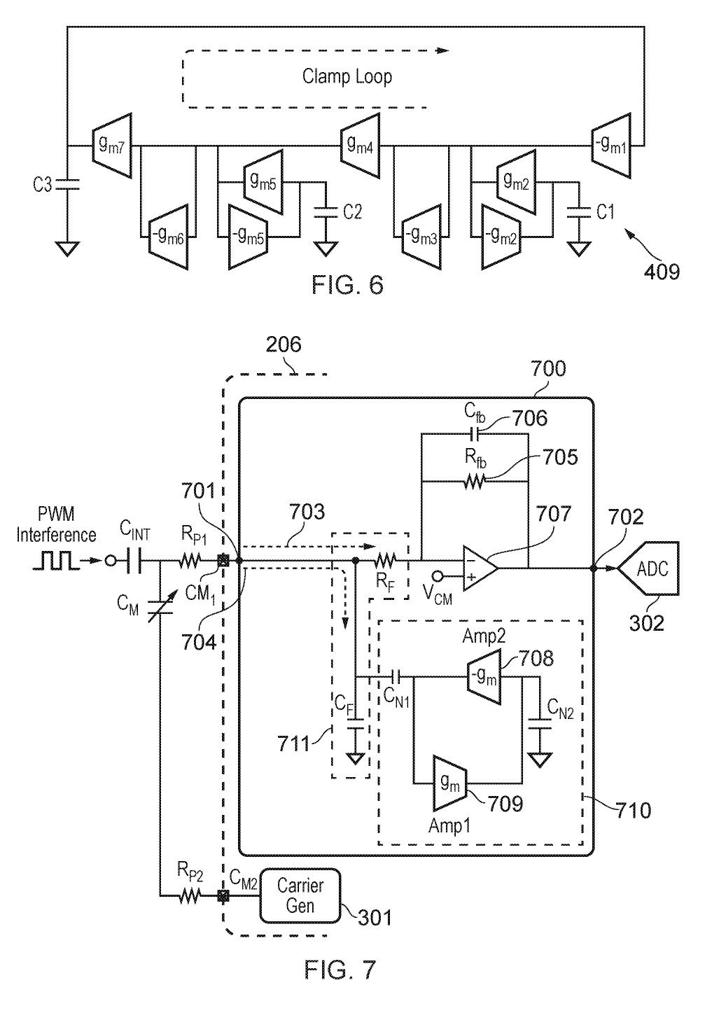

FIG. 7 illustrates an example of an analog front end, AFE, circuit 700 for a capacitive sensor, in accordance with some embodiments. It will be appreciated that the AFE circuit may be used in a capacitance digital converter system 206 as illustrated in FIG. 2. Parts of the capacitance digital converter system 206 are illustrated in FIG. 7 for clarity.

In some examples, the carrier signal may be designed to be of a low frequency. In these examples, the carrier signal may be of a lower frequency than the interference signal. In some examples, the carrier signal may be designed to be of a high frequency. In these examples, the carrier signal may be of a higher frequency than the interference signal.

The AFE circuit comprises an input 701 configured to receive an input signal from the capacitive sensor 204 wherein the input signal comprises a carrier signal and an interference signal, and the interference signal has a higher frequency than the carrier signal. For example, the input 701 may be coupled to the input C_{M1} of the capacitance digital converter system 206. The carrier signal may be generated by a carrier signal generator 301 as described in FIG. 3, for the purpose of measuring the capacitance of the capacitive sensor C_{M}. The interference signal may be due to a parasitic capacitance C_{INT} between a voice coil in a transducer and the capacitive sensor C_{M} as previously described.

The AFE circuit 700 further comprises a first signal path 703 between the input 701, and an output 702, wherein the first signal path 703 is configured with an impedance Z₁ at a frequency of the interference signal. FIG. 4 illustrates an example of the first signal path 703, it will be appreciated that other elements may be included (or some elements removed from this first signal path). The first signal path 403 may also be configured with an impedance Z₂ at a frequency of the carrier signal, where the Z₂ is lower than Z₁ (see FIG. 7 for impedance versus frequency relationship).

In this example, the first signal path 703 comprises an active low pass filter comprising a resistor 705, capacitor 706 and amplifier 707 coupled in parallel, similarly to as in FIG. 4. It will be appreciated that any low pass filter may be used.

The AFE circuit 700 further comprises a second signal path 704 coupled to the input 701. The second signal path 704 is configured with an impedance Z₇ at a frequency of the interference signal, wherein Z₇ is lower than Z₁. FIG. 7 illustrates an example embodiment of a second signal path 704. In particular, the second signal path 704 may be configured with a lower impedance at a frequency of the interference signal than the first signal path 703 so as to reduce a voltage swing caused by the interference signal at the input 701.

In this example, the second signal path 704 comprises a notch filter 710 configured to allow at least one low frequency component of the interference signal to pass through the second signal path 704. In this example, the notch filter 710 is implemented as an active inductor using the transconductance amplifiers 708 and 709 coupled back to back, and capacitors C_{N1} and C_{N2} coupled to ground. It will be appreciated that there may be different designs for the notch filter 710 including both passive and active designs. The notch filter may be centred on a fundamental frequency F_{F} of the interference signal, and may provide the lower impedance value of Z₇ for the fundamental frequency in the second signal path 704.

The notch filter 710 also provides an impedance Z₁₀ for the carrier frequency in the second signal path 704, where Z₁₀ is higher than Z₂ provided in the first signal path 703 for the carrier frequency.

In this example, the second signal path 704 further comprises a high pass filter 711 configured with impedances Z₈ and Z₉ for the higher harmonic frequencies F_{H1} and F_{H2} of the interference signal respectively. In this example, the high pass filter 711 comprises a resistor R_{F} and a capacitor C_{F} coupled to ground. It will be appreciated that any type of high pass filter may be used.

The impedances Z₈ and Z₉ are lower than an impedances Z₄ and Z₅ in the first signal path to the higher harmonic frequencies F_{H1} and F_{H2} of the interference signal respectively. Therefore, the frequencies of the interference signal will be separated from the first signal path 703, and will instead pass through the second signal path 704 where the frequencies of the interference signal are met with a lower impedance. This arrangement therefore predominantly removes the interference signal from the first signal path 703, allowing the output signal at the output 702 to be based on the carrier signal.

The use of a notch filter in this embodiment may avoid the need for a high order high pass filter (for example as illustrated in FIG. 6) in examples where the fundamental frequency of the interference signal is close to the frequency of the carrier signal.

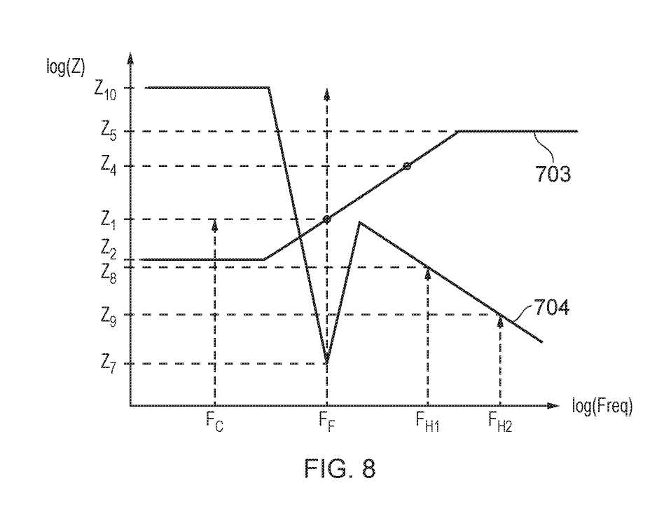

FIG. 8 illustrates a graph of the impedance of the first signal path 703 and the second signal path 704 according to some embodiments.

In this example, the first signal path 703 has an impedance Z₂ at the frequency of the carrier signal, F_{C}. In this example, the first signal path 703 has an impedances Z₄ and Z₅ at the higher harmonic frequencies F_{H1} and F_{H2} of the interference signal respectively, where Z₄ and Z₅ are higher than Z₂. In this example, the first signal path 703 has an impedance Z₁, which is between Z₂ and Z₄, at the fundamental frequency of the interference signal F_{F}.

This first signal path 703 therefore, without the presence of the second signal path, may be effective at filtering out the higher harmonic frequencies F_{H1}, F_{H2} of the interference signal from the first signal path 703. However, this first signal path may be less effective at filtering out the fundamental frequency of the interference signal F_{F}, potentially due to the fundamental frequency of the interference signal F_{F} being relatively close to the frequency of the carrier signal F_{C}. Therefore, without the second signal path 704, the fundamental frequency of the interference signal may cause interference effects in the first signal path 703 which may cause the determination of the displacement of the diaphragm of the transducer to be inaccurate.

In this example however, the second signal path 704 has an impedance Z₁₀ at the frequency of the carrier signal F_{C}, which is higher than the impedance Z₂ to the frequency of the carrier signal in the first signal path 703, thereby ensuring that the carrier signal is passed through the first signal path 703 to be sensed accurately. In this example, the second signal path 704 has an impedance Z₇ at the fundamental frequency of the interference signal F_{F}. This low frequency Z₇ at the fundamental frequency of the interference signal is provided by the notch filter 710. However, an additional filter may be required to ensure that the higher harmonics of the interference signal are also removed from the first signal path 703.

The high pass filter 711 therefore provides the impedances Z₈ and Z₉ at the higher harmonic frequencies F_{H1}, F_{H2} of the interference signal, respectively. The impedances Z₃, Z₈ and Z₉ of the second signal path for the frequencies of the interference signal may be lower than the impedance Z₁ of the first signal path for the fundamental frequency of the interference signal, and lower than the impedances Z₄ and Z₅ for the higher harmonic frequencies in the first signal path.

Therefore, the frequencies of the interference signal will be separated from the first signal path 703, and will instead pass through the second signal path 704 where the frequencies of the interference signal are met with a lower impedance. The configuration of the impedances at different frequencies in the first and second signal paths therefore predominantly removes the interference signal from the first signal path 703, allowing the output signal at the output 702 to be based on the carrier signal.

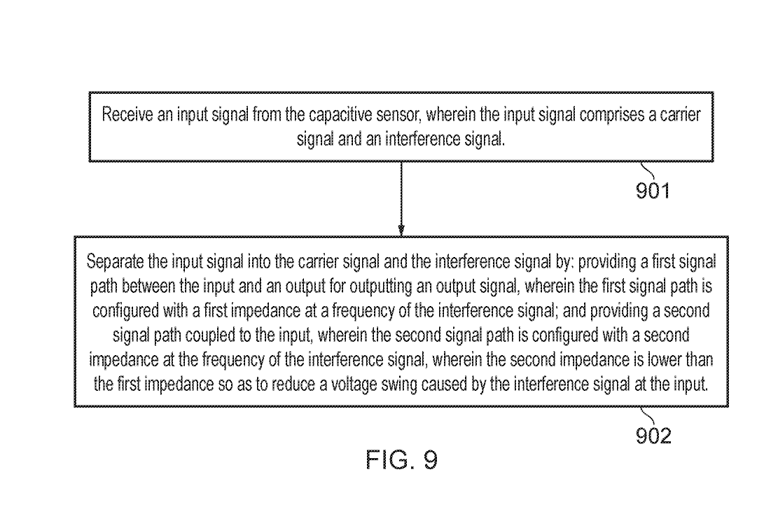

FIG. 9 illustrates a method for separating an interference signal from a carrier signal for sensing a capacitance of a capacitive sensor according to some embodiments.

In step 901, the method comprises receiving an input signal from the capacitive sensor, wherein the input signal comprises a carrier signal and an interference signal.

In step 902, the method comprises separating the input signal into the carrier signal and the interference signal by: providing a first signal path between the input and an output for outputting an output signal, wherein the first signal path is configured with a first impedance at a frequency of the interference signal; and providing a second signal path coupled to the input, wherein the second signal path is configured with a second impedance at the frequency of the interference signal, wherein the second impedance is lower than the first impedance so as to reduce a voltage swing caused by the interference signal at the node.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in the claim, “a” or “an” does not exclude a plurality, and a single feature or other unit may fulfil the functions of several units recited in the claims. Any reference numerals or labels in the claims shall not be construed so as to limit their scope.

The skilled person will thus recognize that some aspects of the above-described apparatus and methods may be embodied as processor control code, for example on a non-volatile carrier medium such as a disk, CD- or DVD-ROM, programmed memory such as read only memory (Firmware), or on a data carrier such as an optical or electrical signal carrier. For many applications embodiments of the invention will be implemented on a DSP (Digital Signal Processor), ASIC (Application Specific Integrated Circuit) or FPGA (Field Programmable Gate Array). Thus, the code may comprise conventional program code or microcode or, for example code for setting up or controlling an ASIC or FPGA. The code may also comprise code for dynamically configuring re-configurable apparatus such as re-programmable logic gate arrays. Similarly, the code may comprise code for a hardware description language such as Verilog™ or VHDL (Very high speed integrated circuit Hardware Description Language). As the skilled person will appreciate, the code may be distributed between a plurality of coupled components in communication with one another. Where appropriate, the embodiments may also be implemented using code running on a field-(re)programmable analogue array or similar device in order to configure analogue hardware.

It should be understood—especially by those having ordinary skill in the art with the benefit of this disclosure—that the various operations described herein, particularly in connection with the figures, may be implemented by other circuitry or other hardware components. The order in which each operation of a given method is performed may be changed, and various elements of the systems illustrated herein may be added, reordered, combined, omitted, modified, etc. It is intended that this disclosure embrace all such modifications and changes and, accordingly, the above description should be regarded in an illustrative rather than a restrictive sense.

Similarly, although this disclosure makes reference to specific embodiments, certain modifications and changes can be made to those embodiments without departing from the scope and coverage of this disclosure. Moreover, any benefits, advantages, or solution to problems that are described herein with regard to specific embodiments are not intended to be construed as a critical, required, or essential feature of element.

Further embodiments likewise, with the benefit of this disclosure, will be apparent to those having ordinary skill in the art, and such embodiments should be deemed as being encompasses herein.

1. An analog front end (AFE) circuit for a capacitive sensor comprising:
an input configured to receive an input signal from the capacitive sensor, wherein the input signal comprises a carrier signal and an interference signal;
a first signal path between the input and an output configured to output an output signal, wherein the first signal path is configured with a first impedance at a frequency of the interference signal; and
a second signal path coupled to the input, wherein the second signal path is configured with a second impedance at the frequency of the interference signal, wherein the second impedance is lower than the first impedance so as to reduce a voltage swing caused by the interference signal at the input.

2. The AFE circuit of claim 1 wherein the first signal path is configured with a third impedance at a frequency of the carrier signal and the second signal path is configured with a fourth impedance at the frequency of the carrier signal, wherein the third impedance is lower than the fourth impedance.

3. The AFE circuit of claim 1, wherein the first signal path comprises a first low pass filter configured to filter high frequency components of the interference signal from the first signal path.

4. The AFE circuit of claim 1 wherein the second signal path comprises a high pass filter configured to filter the carrier signal from the second signal path.

5. The AFE circuit of claim 4 wherein the high pass filter is configured to pass the interference signal through the second signal path.

6. The AFE circuit of claim 4 wherein the high pass filter comprises an Nth order filter where N>6.

7. The AFE circuit of claim 1 wherein the second signal path comprises a notch filter configured to allow at least one frequency component of the interference signal to pass through the second signal path.

8. The AFE circuit of claim 7 wherein the second signal path further comprises a second high pass filter configured to pass higher frequency components of the interference signal than the at least one frequency component into the second signal path.

9. The AFE circuit of claim 7 wherein the at least one frequency component comprises a fundamental frequency of the interference signal.

10. The AFE circuit as claimed claim 7 wherein the notch filter comprises an active inductor.

11. The AFE circuit of claim 10 wherein the active inductor comprises two transconductance amplifiers and two capacitors.

12. The AFE circuit of claim 1 wherein the interference signal has a higher frequency than the carrier signal.

13. A method for separating an interference signal from a carrier signal for sensing a capacitance of a capacitive sensor, the method comprising:
receiving an input signal from the capacitive sensor, wherein the input signal comprises a carrier signal and an interference signal;
separating the input signal into the carrier signal and the interference signal by:
providing a first signal path between the input and an output for outputting an output signal, wherein the first signal path is configured with a first impedance at a frequency of the interference signal; and
providing a second signal path coupled to the input, wherein the second signal path is configured with a second impedance at the frequency of the interference signal, wherein the second impedance is lower than the first impedance so as to reduce a voltage swing caused by the interference signal at the input.

14. The method of claim 13 wherein the first signal path is configured with a third impedance at a frequency of the carrier signal and the second signal path is configured with a fourth impedance at the frequency of the carrier signal, wherein the third impedance is lower than the fourth impedance.

15. The method of claim 13, wherein the first signal path comprises a first low pass filter configured to filter high frequency components of the interference signal from the first signal path.

16. The method of claim 13 wherein the second signal path comprises a high pass filter configured to filter the carrier signal from the second signal path.

17. The method of claim 14 wherein the high pass filter passes the interference signal through the second signal path.

18. The method of claim 13 wherein the second signal path comprises a notch filter configured to allow at least one frequency component of the interference signal to pass through the second signal path.

19. The method of claim 18 wherein the second signal path further comprises a second high pass which passes higher frequency components of the interference signal than the at least one frequency component into the second signal path.

20. The method of claim 13 wherein the interference signal has a higher frequency than the carrier signal.
